(19) United States
(12) Patent Application Publication
(10) Pub. No.: US 2005/0003101 A1
(43) Pub. Date: Jan. 6, 2005

(54) High resolution patterning method

(76) Inventors: William Norman Damerell, Hampshire (GB); Daniel Robert Johnson, Malvern Worcestershire (GB); Anthony William Nigel Kynaston-Pearson, Hampshire (GB); Greg Peter Wade Fixter, Hampshire (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/494,181

(22) PCT Filed: Oct. 25, 2002
(86) PCT No.: PCT/GB02/04837

(30) Foreign Application Priority Data
Oct. 29, 2001 (GB) 0125815.1

(51) Int. Cl. B05D 1/18

(52) U.S. Cl. 427/554; 427/256; 427/443.1

(57) ABSTRACT

This invention relates to a method of forming high resolution patterns of material on a substrate by way of catalytic reactions.

This invention relates to a method of forming high resolution patterns of material on a substrate and encompasses the fields of catalytic reactions (especially autocatalytic coating methods) and also scribing methods using energetic media.

“Scribing” refers to the techniques of ablating accurate and narrow patterns or lines in a target material. In such methods an energetic media such as a laser, AFM (Atomic Force Microscope), STM (Scanning Tunnelling Microscope), ion, or electron beam is used to scribe the pattern into the target material.

Autocatalytic plating is a form of electrode-less (electroless) plating in which a metal is deposited onto a substrate via a chemical reduction process. The advantage of this technology is that an electric current is not required to drive the process and so electrical insulators can be coated. Coatings derived by this technique are usually more uniform and adherent than from other processes and can be applied to unusually shaped surfaces (see Deposition of Inorganic Films from Solution, Section III Ch 1 pp 209-229; Thin Film processes (1978); Publishers Academic Press and, Smithells Metals Reference Book, 7^{th} Edition (1992) Chapter 32, pp12-20; Publishers Butterworth Heinmann.)

Processes exist for the autocatalytic deposition of a large number of metals, particularly cobalt, nickel, gold, silver and copper from a suitable solution bath. Basically, the solutions contain a salt of the metal to be deposited and a suitable reducing agent, e.g. hypophosphite, hydrazine, borane etc. When a metal substrate, which is catalytic to the reaction, is introduced into the solution bath it becomes covered with a layer of the coating metal which itself is catalytic so that the reaction can continue.

Deposition will only occur if conditions are suitable on the substrate to initiate and then sustain the autocatalytic process. Therefore in cases where the substrate is a plastic or ceramic, for example, additional steps are required to create suitable surface properties. Usually, in such cases the substrate is “sensitised” with a reducing agent, e.g. SnCl₂. Also, the surface may be “activated” with a thin layer of an intermediate catalytic material, e.g. Palladium (itself a candidate metal for autocatalytic deposition), in order to aid the deposition process. Such “deposition promoting materials” are generally referred to in the literature as “sensitisers” and “activators” respectively.

Autocatalytic deposition is generally employed to coat whole surfaces. However, in order to form metal patterns, e.g. for electrical circuits or decorative effects, additional processes such as photolithography followed by etching of surplus metal have to be performed. There are disadvantages to these additional processes, including inflexibility, long lead times, increased costs and the use of excessive materials to provide coatings much of which is then subsequently removed as waste.

There are many types of catalytic reaction (including the autocatalytic reaction described above) that can take place over the surface of a substrate material and such reactions can be used to increase the rate of or activate reactions in gas, liquid or solid environments.

The “catalytic materials” that are used in such reactions include “deposition promoting materials” (as defined above) but also include other heterogeneous catalysts and homogeneous catalysts. Heterogeneous catalytic materials include metals such as platinum, rhodium and palladium and metal oxides containing catalytic sites, e.g. perovskite cage structures. These catalysts are used in synthetic or decomposition reactions in organic or inorganic chemistry, for example in the Fischer-Tropsch synthesis of organic molecules from hydrogen and carbon monoxide, cracking, or in the decomposition of hydrocarbons. Homogeneous catalytic materials include enzymes which are used, for example in biochemical testing in diagnostic arrays and for de-compositional analysis of biopoloymers and systems that mimic proteozone behaviour. Homogeneous catalysts also include negative catalysts, commonly known as inhibitors, which moderate reactions.

The “catalytic materials” could also include “precursor catalytic materials” that are not initially catalytically active but which can be activated in a simple manner, e.g. by exposure to heat or radiation.

Generally in such reactions the catalytic material used is either applied to or is effective over the whole of the substrate material and as a consequence the reaction takes place over the whole of the substrate.

It is therefore an object of the present invention to provide a method of preparing a substrate material such that it is capable of initiating a catalytic reaction over a pre-determined area of its surface.

Accordingly, this invention provides a method of preparing a substrate such that it is capable of sponsoring a catalytic reaction over a pre-determined area of its surface comprising the steps of:
i) coating some or all of the substrate material with a first layer material, the first layer material comprising a catalytic material (as hereinbefore defined)
ii) coating the first layer material with a second layer material such that the second layer overlaps the first layer to form a seal, the second layer material being incapable of promoting and/or sustaining the desired catalytic reaction
iii) using a scribing process (as hereinbefore defined) to remove a pre-determined pattern of material from the second layer material in order to expose the first layer material
   wherein
the first layer material is printed onto the substrate by a pattern transfer mechanism and the second layer is printed onto the first layer material by a pattern transfer mechanism.

The invention is basically a three stage process which results in a substrate that has been prepared in such a way that it will sponsor a catalytic reaction over only part of its surface. The substrate, which may be any material, for example, metal(s), organic/inorganic compounds, ceramics or polymers, is initially treated with a material that will allow the substrate to sponsor a catalytic reaction. For example, if the catalyst material is a deposition promoting material then the substrate will be capable of being metal plated via an autocatalytic process. Alternatively, the catalyst may be a reaction promoting material for example aluminium chloride used in the electrophilic substitution in the Friedel-Crafts reaction.

The first layer of catalyst material is then coated with a second layer which is unable to sponsor the desired catalytic reaction. In order to form a seal the second layer slightly overlaps the first layer.

A scribing process, for example a laser scriber, is then used to scribe through the second layer in order to expose user defined areas of the first layer. Conveniently, the scribing process may be tuned to do this without undue damage to the first layer and materials may be selected to enhance the specificity of the process. Equally, the scribing process may be used to produce grooves, pits or holes through both of the layers which at the same time transfers catalytic material from the first layer into these features for subsequent catalytic reaction.

This invention has a number of advantages over other process. The catalytic reaction will, once initiated, only occur within the scribed areas of the second layer as opposed to other processes which would involve etching in order to create the user defined patterns. There is therefore a reduction in the amount of wasted material.

The lines/patterns of catalytic material are constrained within the profile of the scribed line/groove. This reduces lateral spread of material into areas where there is no requirement for a catalytic reaction. The scribing grooves also offer protection from mechanical damage. In cases where the catalytic reaction involves deposition of a material (e.g. deposition of a metal plating in an autocatalytic reaction) then conveniently a further sealing layer can be added in order to encapsulate the deposited metal pattern.

Any suitable pattern transfer mechanism may be used to deposit the first layer material onto the substrate. Examples include (but are not limited to) inkjet printing, screen printing, pen writing or spray printing. The same (or different) pattern transfer mechanism can also be used to coat the first layer material with the second layer material.

The minimum feature sizes that result from the use of a pattern transfer technique are dependent on the particular mechanism used. For an ink jet printing technique features of the order 20 microns are possible. Screen printing and/or pen writing result in much coarser features being produced, e.g. up to 1000 microns. Features in the range 20-1000 microns are therefore possible depending on the mechanism used.

The use of pattern transfer mechanisms to apply the first and second layer materials further reduces the amount of material that needs to be applied to the substrate and therefore further reduces waste material.

Alternatively, the catalytic material of the first layer material could be printed onto the surface as a “precursor catalytic material” that, once exposed to an energetic medium, is converted into a catalytic material that will allow the substrate to sponsor a catalytic reaction. There are a wide range of compounds that are suitable as precursor catalytic materials. Examples include compounds of metals e.g. palladium chloride, ruthenium acetate, copper oxide, ammonium metavanadate, nickel acetate, nickel carbonyl etc. These materials may be converted into metals or oxides of metals supported on substrates and find uses in a range of catalysed reactions e.g. the Fischer-Tropsch synthesis of organic molecules from hydrogen and carbon monoxide. Furthermore, energetic media can be used to convert biological material into catalytic materials. For example, light activation can cause conformational changes in proteins or release free radical molecules (e.g. in ethylene oxydase or superoxide dismutase). Also, energetic media can be used to convert caged molecules comprising a biopolymer into an enzyme which can then catalyse a reaction. An example of this case is when an ATP molecule (molecule coated with a protective group) is exposed to an energetic medium upon which the protective group falls away and an enzyme is triggered.

The conversion process can be achieved by any one of a range of energetic media, for example a laser. A further example of an energetic media used in the conversion process is an electron beam, which can reduce precursor catalytic materials to metals or oxides. An electron beam can be used to decompose precursor catalytic material directly to the desired catalyst and/or utilise a chemical reducing agent in the gas, liquid or solid phase. The chemical reducing agent may be provided by decomposition of the precursor catalytic material itself exposed to the energetic media, for example carbon monoxide will be produced from thermal decomposition of a metal oxalate.

It is possible that the second layer material will not always completely seal the first layer material. In such cases the catalytic reaction may also occur in areas that have not been scribed, for example because there is a hole in the second layer. There is therefore an additional advantage to using a precursor catalytic material since the conversion energetic medium can be chosen only to activate material within the scribed area. Any areas of the first layer that are exposed due to an imperfection in the sealing second layer will not be activated because they do not fall within the scribed pattern.

Conveniently, the catalytic material can be synthesised from the printing of inks containing reagents that react together at a printed surface or can be contained directly in an ink formulation. The inks may be printed into a user-defined pattern with a chosen pattern transfer mechanism.

The second layer which is deposited onto the first layer comprises a material that is unable to promote the catalytic reaction. This second layer material is applied using a pattern transfer mechanism and can be contained within an ink formulation of its own which is suitable for use with the chosen pattern transfer mechanism. The pattern transfer mechanism used to deposit the second layer material need not be the same as the pattern transfer mechanism used to deposit the first layer material.

Conveniently, the ink formulations, for both the first and second layers, can, in addition to the first and second layer materials, contain binders and fillers which can enhance the properties of the intended catalytic process.

Any organic/inorganic material that will solidify or “set” and be adhered to the printable surface of the substrate may be used as a binder. Examples may be ink solutions containing polymers e.g. poly(vinyl acetate), acrylics, poly(vinyl alcohol) and/or inorganic materials that behave as cements or sol-gels coatings, e.g titanium isopropoxide and other alkoxides.

Fillers comprise insoluble particles contained in the ink that are small enough to transfer from the printer mechanism. Typically, 10-200 nm carbon black particles are added to colour inkjet inks and 1-100 micron graphitic carbon is added to screen-printable inks used in the fabrication of printed electrical conductors. Ceramics, organic dyes or polymer particles may be added to ink to provide colour and/or texture in the printed product e.g. titania, alumina, mica, glass, acrylics. The ink may therefore be formulated with any of these components and include the catalytic material to provide a wide range of properties.

The scribing process can be any one of a range of energetic ablation methods, for example a laser. Other suitable methods may include focused UV beam, collimated X-ray beam, particle beams, plasma beams or even a fine gas jet. The chosen scribing process can either be used to expose the first layer material without causing undue damage or alternatively it may be used to remove (or burn off in the case of a laser scribing process) unwanted materials in the first layer in order to leave a more concentrated form of catalytic material.

The ink formulations for the first and second layers may conveniently be chosen to contain materials that enhance the scribing process. For example, the binders in the two layers may have different melting temperatures to enhance the scribing process. The ink formulations may also contain fillers that absorb or reflect energy in order to actively assist in the retention of the catalytic material upon the substrate material.

The ink formulations may also contain materials that are sensitive to the particular scribing process that is used. For example, with a laser scribing process there are a large variety of laser types operating at different frequencies that could be used. The laser energy impinging on the target material could therefore be arranged to be reflected, transmitted or absorbed in a particular way dependent on the optical absorption characteristics of the materials contained in the first and second layer materials.

Once the substrate has been prepared in the manner described above then it can be introduced into a reaction environment suitable to initiate the required catalytic process. For example, if the chosen catalytic reaction is an autocatalytic coating method then the final stage of the process is to deposit a metal into the scribed areas. This can be achieved by immersing the substrate in a suitable autocatalytic solution bath. In general terms the catalysed surface may be exposed to any reaction environment, including gas, vapour, liquid, solution or solid.

Certain catalytic reactions (such as the autocatalytic reaction above) will result in material being deposited onto the prepared substrate and in such cases the process according to the invention can be repeated in order to build up multiple material layers/patterns. Insulator layers can also be added to separate these different layers.

The resolution of the deposited material patterns is limited only by the characteristics of the scribing process.

Autocatalytic reactions are used to deposit metal onto a substrate. Such processes are generally used to deposit whole surfaces. However, the process according to the present invention can be used to deposit metal patterns in a pre-determined user defined manner. To deposit a metal coating the catalytic material is chosen to be a deposition promoting material. The prepared substrate in this case will then be suitable for subsequent metal plating by immersion in a suitable autocatalytic deposition solution.

The metal coating which is deposited into the scribed grooves by the autocatalytic deposition process may subsequently be coated with further metals through electroless deposition, provided the first autocatalytically deposited metal coating surface can catalyse or ion exchange with the subsequent metals. For example the exposed areas of a sensitised substrate may be autocatalytically coated with a layer of nickel which could then be further coated, via a further electroless process, with a coating of copper. Alternatively, if the first electroless coating is copper a further coating of tin may be deposited.

It is also possible for the autocatalytic deposition solution to contain two different metal salts which are then co-deposited onto a sensitised substrate at the same time, for example nickel and copper.

An autocatalytically deposited metal pattern may also be further coated with a wide range of metals or compounds by electrodeposition, provided there are continuous electrical paths in the pattern to act as the cathode of an electrolytic bath. An example is the electrodeposition of “chromium” plate onto nickel to prevent tamishing.

Conveniently, the deposition promoting material can be contained in an ink formulation suitable for use with the chosen pattern transfer mechanism.

Conveniently, the ink formulations, for both the first and second layers, can, in addition to the first and second layer materials, contain binders and fillers which variously can enhance the properties of the final metal coating, enhance the adhesion of the electroless metal to the substrate and which can provide porous and textured surface effects, which can change the mechanical, thermal, electrical, optical, and catalytic properties of depositing metal.

The inclusion of binders in the ink formulation may additionally serve to prevent loss of adhesion from the printed substrate of the deposition promoting agent during electroless coating. The inclusion of fillers may serve to improve contact between the deposition promoting agent and the autocatalytic solution bath.

As an alternative to including binders and fillers within the ink formulation the substrate may incorporate a porous layer which can influence the adhesion, scratch resistance and texture of the subsequent electroless metal coating. However, it may also be preferable to have an impervious substrate surface to maintain the integrity and resolution of the printed feature according to need.

The deposition promoting material may comprise a reducing agent (a “sensitiser”) such as SnCl₂, glucose, hydrazine, amine boranes, borohydride, aldehydes, hypophosphites, tartrates.

As an alternative to, or as well as, a reducing agent, the deposition promoting material could be an activator such as a colloidal dispersion of a catalytic material. For example palladium, cobalt, nickel, steel or copper could be added to an ink formulation to catalyse a particular metal deposition.

As a further alternative, the deposition promoting material could be one that is able to ion exchange with the catalytic material contained within the autocatalytic solution bath. For example, Ni or Fe could be added directly to an ink formulation. Once the coated substrate is introduced into the autocatalytic solution bath the deposition promoting material undergoes ion exchange with the metal in the autocatalytic solution, thereby nucleating deposition of the electroless coating.

Where a chemical reducing agent is deposited onto a substrate to become the deposition promoting agent, the method may conveniently comprise a further step of immersing the now “sensitised” substrate into an intermediate solution bath of reducible metal ions (prior to the final autocatalytic solution bath), to provide an “activating” metal overlayer on the deposition promoting agent. This further step has the effect of aiding the deposition promoting material and promoting easier deposition of certain metals (such as copper, nickel and cobalt).

For example, for the case of an ink formulation containing SnCl₂ as the deposition promoting material, once the substrate material has had the SnCl₂ applied to it, it can be immersed into an intermediate solution bath comprising a dilute aqueous solution of PdCl₂. This causes the deposition of Pd metal onto the areas of the substrate coated with the deposition promoting material. If the Pd “activated” substrate is now immersed into an autocatalytic solution then autocatalytic deposition will take place onto the Pd metal. Such an intermediate step is useful in cases where the metal to be deposited from the autocatalytic deposition bath is either copper, nickel or cobalt.

As an alternative to the above the ink formulation could contain PdCl₂ instead of SnCl₂. Following deposition of this onto the substrate, an intermediate step could be to convert the PdCl₂ on the surface of the substrate to Pd metal by immersion in a dilute aqueous solution of SnCl₂. The application of the second layer material, scribing process and immersion in an autocatalytic deposition bath could then take place as before.

In a further alternative, the intermediate step could be omitted by using a “reduced” complex as the deposition promoting material, i.e. the deposition promoting material could be formulated to contain a combination of chemical species comprising both a reducing agent and an activator. For example, both SnCl₂ (sensitiser) and PdCl₂ (activator) could be added to the ink formulation. Following deposition of this first layer material onto the substrate the first layer material could then be coated with the second layer material, scribed using an appropriate scribing process and the substrate could then be introduced immediately into the autocatalytic deposition solution to deposit the metal of choice.

A variant of the above “reduced” complex option would be to use two sequential printing mechanisms, one containing the sensitiser material and the other containing a compound of a metal that can be reduced to an activator material. For example, if a sensitiser like SnCl₂ dissolved and contained in an ink having a binder is printed onto a printed ink layer containing dissolved PdCl₂ and binder, then the two reagents will react whilst solvated to form a reduced complex containing catalytic Pd metal at the interface between the printed layers. In the instance that the sensitiser is unable to promote a reaction in the autocatalytic solution bath, then the layer containing the sensitiser is also suitable as the second layer (as before defined). Otherwise another layer unable to sponsor reaction may be preferred to seal in both the sensitiser and activator materials. Once again the catalytic activator material is then accessed through a scribing process.

Examples of precursor catalytic materials that can be converted into deposition promoting materials are compounds of metals that can be reduced to a metal that will activate the coated areas of the substrate for electroless deposition. For example, compounds of palladium or others from the platinum group could be reduced to their metal forms such that they are then capable of sponsoring an autocatalytic reaction.

Precursor catalytic materials may also include metal compounds that are reduced to a metal that will sponsor the autocatalytic deposition of the same metal from an autocatalytic deposition solution. For example, copper salts (as the precursor catalytic material) may be reduced by an electron beam to copper metal which is able to nucleate autocatalytic copper deposition. Similarly, an electron beam can reduce nickel from one if its salts. Nickel can also be used as a deposition promoting material that will ion exchange with copper in the autocatalytic solution bath. Once the metals have exchanged the copper on the substrate will then autocatalyse further copper from solution.

Embodiments of the present invention will now be described with reference to the accompanying drawings in which:

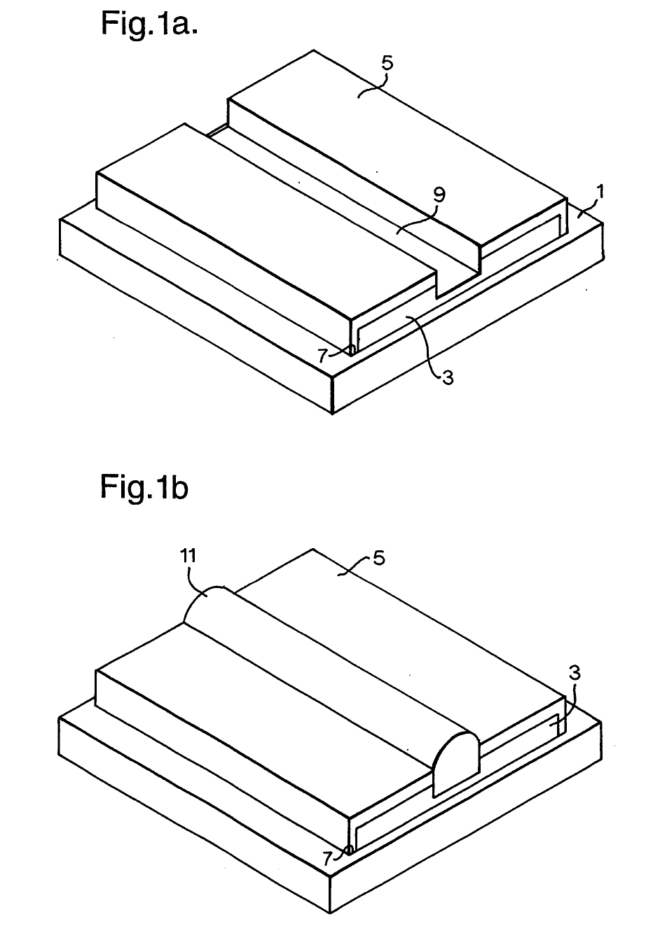

FIG. 1a shows the three stage preparation process described above as applied to a substrate material to be used in an autocatalytic plating process.

FIG. 1b shows the final stage of depositing a metal plating on the substrate depicted in FIG. 1a

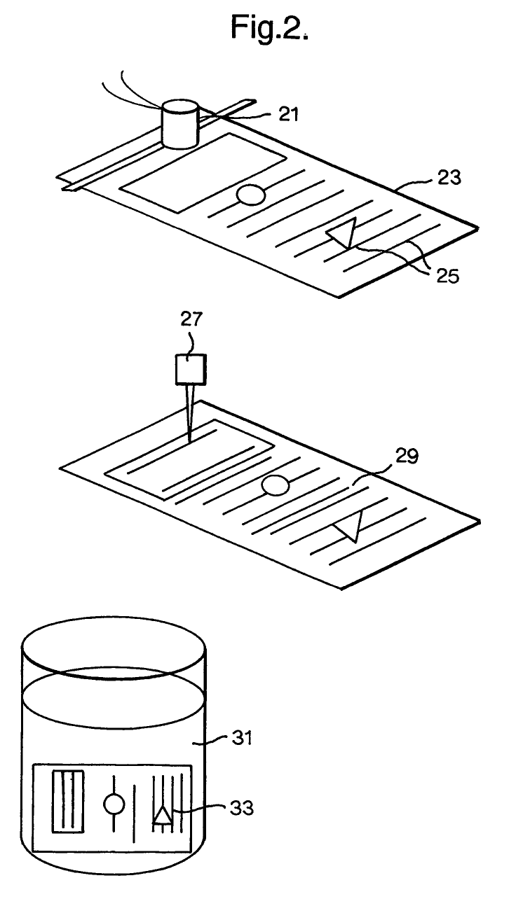

FIG. 2 shows the complete process of producing a metalised substrate.

Turning to FIG. 1a, a substrate 1 has been partially coated with a first layer material 3 which comprises an electroless deposition promoting material. The first layer 3 has been subsequently coated with a second layer material 5 which is unable to promote electroless deposition. The first and second layers (3, 5) may have been applied via a suitable pattern transfer mechanism, e.g. injet printing, to the substrate.

The second layer 5 overlaps the first layer 3 and forms a seal 7 with the substrate 1 below.

A suitable scribing mechanism (e.g. laser scribing) has removed material (depicted by the scribed groove 9) from the second layer to expose the material in the first layer.

FIG. 1b shows the substrate material from FIG. 1a after it has been immersed in a suitable autocatalytic deposition solution bath. A metal 11 has now been deposited into the scribed groove 9.

Turning to FIG. 2, an inkjet printing system 21 coats a substrate 23 with an ink formulation containing a deposition promoting material in a user determined pattern 25. This first layer comprising the deposition promoting material is then coated with a second layer of material that cannot promote autocatalytic deposition.

A scribing mechanism 27 then ablates part of the second layer of material on the coated substrate to produce grooves 29 in which the first layer of deposition promoting material is exposed.

The “scribed” substrate is then immersed into an autocatalytic solution 31 to produce a user defined metallic pattern 33.

1-21. (Cancelled)

22. A method of preparing a substrate such that it is capable of sponsoring autocatalytic plating of metal patterns over a pre-determined area of its surface comprising the steps of:
i) coating some or all of the substrate material by a pattern transfer mechanism with a first layer composed of a first layer material comprising a catalytic material;
ii) coating the first layer by a pattern transfer mechanism with a second layer composed of a second layer material such that the second layer overlaps the first layer to form a seal, the second layer material being incapable of promoting and/or sustaining the desired catalytic reaction
iii) using an energetic ablative scribing process to remove a pre-determined pattern of material from the second layer material in order to expose the first layer material.

23. A method of preparing a substrate as claimed in claim 22 wherein the first layer material is a precursor catalytic material and the method further comprises the step of converting the precursor catalytic material into a catalytic material by exposing the precursor catalytic material to an energetic medium.

24. A method of preparing a substrate as claimed in claim 22 wherein the pattern transfer mechanism used to deposit the first layer is ink-jet printing.

25. A method of preparing a substrate as claimed in claim 22 wherein the pattern transfer mechanism used to deposit the second layer is ink-jet printing.

26. A method of preparing a substrate as claimed in claim 22 wherein the catalytic material is contained within an ink formulation.

27. A method of preparing a substrate as claimed in claim 26 wherein the ink formulation contains additional binders and/or fillers capable in use of enhancing the catalytic reaction.

28. A method of preparing a substrate as claimed in claim 22 wherein the scribing process is performed by a laser.

29. A method of preparing a substrate material for subsequent metal plating by an autocatalytic deposition process as claimed in claim 22 wherein the substrate material comprises an impermeable surface layer.

30. A method of preparing a substrate material for subsequent metal plating by an autocatalytic deposition process as claimed in claim 22 wherein the substrate material comprises a porous surface layer.

31. A method of depositing metal patterns on a substrate by an autocatalytic deposition process comprising the steps of:
i) preparing a substrate material according to claim 1 wherein the catalytic material in the first layer material is a deposition promoting material which is capable, once the coated substrate is introduced into an autocatalytic solution, of facilitating the deposition of a metal coating from an autocatalytic solution onto the substrate, and
ii) introducing the prepared substrate material from step (i) into an autocatalytic deposition solution, the autocatalytic deposition solution comprising a metal salt and a reducing agent.

32. A method as claimed in claim 31 wherein the steps (i) and (ii) are repeated in order to deposit multiple layers of metal onto the substrate.

33. A method as claimed in claim 31 comprising the further step of introducing the coated substrate from step (ii) of claim 31 into a further autocatalytic solution comprising a further metal salt and a reducing agent.

34. A method as claimed in claim 31 comprising the further step of introducing the coated substrate material from step (ii) of claim 31 into an electrolytic bath in order to electrodeposit a further metal.

35. A method as claimed in claim 31 wherein the autocatalytic solution contains two or more metals salts in solution.

36. A method as claimed in claim 31 wherein the deposition promoting material comprises a reducing agent.

37. A method as claimed in claim 31 wherein the deposition promoting material is SnCl₂.

38. A method as claimed in claim 31 wherein the deposition promoting material comprises an activator comprising a colloidal dispersion of a catalytic material which is capable, once the substrate is introduced into an autocatalytic solution, of initiating and sustaining an autocatalytic reaction.

39. A method as claimed in claim 31 wherein the method additionally comprises an additional step between step (i) and step (ii), said additional step comprising introducing the substrate prepared according to claim 1 into an aqueous metal salt solution with which the deposition promoting material will react to reduce the metal from the aqueous metal solution onto those parts of the first layer that have been exposed by the scribing process, the reduced metal being selected such that it is capable, once the treated substrate is introduced into an autocatalytic solution, of catalysing the deposition of a further metal from an autocatalytic deposition solution.

40. A method as claimed in claim 31 wherein the deposition promoting material comprises a combination of reducing agent and activator.

41. A method of metal plating a substrate by an autocatalytic deposition process comprising the steps of:
(i) preparing a substrate material according to claim 22 wherein the first layer material is a precursor to a deposition promoting material which, once converted to a deposition promoting material, is capable, once the coated substrate is introduced into an autocatalytic solution, of facilitating the deposition of a metal coating from an autocatalytic solution onto the substrate, and
(ii) converting the precursor layer into a deposition promoting material by an energetic medium, and
(iii) introducing the prepared substrate material from step (ii) into an autocatalytic deposition solution, the autocatalytic deposition solution comprising a metal salt and a reducing agent.
